(19) United States
(12) Patent Application Publication
(10) Pub. No.: US 2025/0324335 A1
(43) Pub. Date: Oct. 16, 2025

(54) METHODS AND APPARATUS OF OPERATING USER EQUIPMENT AND NETWORK DEVICES

(71) Applicant: NOKIA TECHNOLOGIES OY, Espoo (FI)

(72) Inventors: Halit Murat Guersu, Munich (DE); Philippe Godin, Versailles (FR); Alessio Casati, West Molesey (GB); Omer Bulakci, Munich (DE); Muhammad Nasser-Ul-Islam, Munich (DE); Ahmad Awada, Munich (DE); Ugur Baran Elmali, Munich (DE)

(21) Appl. No.: 18/998,719

(22) PCT Filed: May 5, 2022
(86) PCT No.: PCT/EP2022/062200

§ 371 Date: Jan. 27, 2025

(51) Int. Cl. H04W 36/00; H04W 76/27

(52) U.S. Cl. CPC H04W 36/13; H04W 76/27

(57) ABSTRACT

Techniques for operating a user device in a communications network are provided. For example, a method of operating a user device in a communications network is disclosed. The method comprises: determining at a change of the user device from a first coverage area providing a network slice allowed for the user device to a second coverage area not providing the network slice, suspending data transmission of a data session established in the first coverage area or another coverage area for the network slice, and maintaining a user device data session context for the data session.

### TECHNICAL FIELD

The subject disclosure generally relates to wireless communication systems and more particularly, to operating user equipment and network devices in a communications network.

### BACKGROUND

Wireless telecommunication systems are under constant development. There is a constant need for higher data rates and high quality of service. Reliability requirements are constantly rising and ways and means to ensure reliable connections and data traffic while keeping transmission delays minimal are constantly under development.

Developing networks enable new services to customers. One service is network slicing, which enables offering connectivity, quality of service and data processing solutions tailored to specific customers' requirements. A network slice is a logical end-to-end virtual network that can be dynamically created and that provides specific capabilities and characteristics. Multiple network slices may be created on top of a common shared physical network infrastructure to run services that may have different requirements on latency, reliability, throughput and mobility.

For example, in 5G, network slicing will be a key feature to support different services using the same underlying mobile network infrastructure.

### SUMMARY

According to a first aspect of the subject disclosure, a method of operating a user device in a communications network is provided. The method according to the first aspect may be performed by the user device. The method comprises: determining a change of the user device from a first coverage area providing a network slice allowed for the user device to a second coverage area not providing the network slice, suspending data transmission of a data session established in the first coverage area or another coverage area for the network slice, and maintaining a user device data session context for the data session.

Suspending the data transmission may be also referred to as pausing the data transmission.

Suspending and pausing the data transmission is particularly meant to indicate that information, parameter, processes etc. related to the data transmission, which are necessary, for example, to provide the data to be transmitted and/or to affect the actual transmission of data are maintained in such a way that no actual data transmission is performed during suspension of the data transmission, but can be resumed, restarted, continued or the like after suspension of the data transmission.

In the following some exemplary, not limiting illustration are given in the following. For example, suspending an ongoing data transmission may result in a scenario where the data to be transmitted are retained at the sender. In another example, assume a case where presently no data is to be actually transmitted, but a the sender side such is data is or will be generated. Then, suspending the data transmission may result in a scenario where data to be transmitted is generated but not transmitter and kept at the sender, or in a scenario where the generation of data to be transmitted is delayed during the suspension.

In some embodiments of the first aspect the method may be used to allow operating the user device in at least one registration area.

In some embodiments of the first aspect, the method may be used in at least one non-homogenous network slice scenario and/or at least one homogenous network slice scenario.

In some embodiments of the first aspect, the suspending may include releasing a user device data radio bearer related to the data session or deactivating the user device data radio bearer.

In some embodiments of the first aspect, the determining may include receiving a message from the communications network that the network slice is not provided.

In some embodiments of the first aspect, the determining may include receiving a message from the communications network indicating to the user device to suspend the data session.

In some embodiments of the first aspect, the message from the communications network may be an RRC reconfiguration message.

In some embodiments of the first aspect, the determining may include detecting, by the user device, that the network slice is not provided.

In some embodiments of the method according to the first aspect, the maintaining includes, by the user device, maintaining the data session at a non-access stratum and suspending the data session at an access stratum.

In some embodiments of the first aspect, the method may include that the first coverage area is a first tracking area, and/or the second coverage area is a second tracking area.

In some embodiments of the first aspect, the data session is a PDU session.

In some embodiments of the first aspect, the user device is in a connected mode in at least one of the first coverage area and the second coverage area.

According to a second aspect of the subject disclosure, a method of operating a network device in a communications network is provided. The communications network comprises a first coverage area providing a network slice allowed for a user device and a second coverage area not providing the network slice. The method according to the second aspect may be performed by one or more network nodes. The method comprises: sending a message to the user device indicating a change from a first coverage area providing a network slice allowed for the user device to a second coverage area not providing the network slice, the message including information indicating to the user device to suspend a data session established for the network slice, receiving, from the user device, a message indicating the change from the first coverage area to the second coverage area.

In some embodiments of the second aspect, the method may be used to allow operating the user device in at least one registration area.

In some embodiments of the second aspect, the method may be used in at least one of non-homogenous network slice scenario and a homogenous network slice scenario.

In some embodiments of the second aspect, the first coverage area may be a first tracking area, and/or the second coverage area may be a second tracking area.

In some embodiments of the second aspect, the data session may be a PDU session.

In some embodiments of the method according to the second aspect, the method may further comprise maintaining a network device data session context for the data session, preferably if the user device is in the second coverage area.

In some embodiments of the method according to the second aspect, the method may further comprise deactivating a network data radio bearer related to the network slice data session upon receiving the message indicating the change from the first coverage area to the second coverage area.

In some embodiments of the second aspect, the deactivating the network data radio bearer comprises deactivating a tunnel related to the data session and/or maintaining data session context for the network slice while the user device is in the second coverage area.

In some embodiments of the method according to the second aspect, the method may further comprise buffering and/or discarding downlink data of the network slice after receiving the message indicating the change from the first coverage area to the second coverage area.

In some embodiments of the method according to the second aspect, the method may further comprise indicating the amount of discarded data to the communications network.

According to a third aspect of the subject disclosure, a method of operating a user device in a communications network is provided. The method according to the third aspect may be performed by the user device. The method comprises: determining a change of the user device from a second coverage area not providing a network slice allowed for the user device to a first coverage area not providing the network slice, re-activating data transmission of a data session from a user device data session context maintained at the user device, wherein the data session has been previously established for the network slice in the first coverage area or another coverage area providing the network slice allowed for the user device.

In some embodiments of the third aspect, the method may be used to allow operating the user device in at least one registration area.

In some embodiments of the third aspect, the method may be used in at least one of non-homogenous network slice scenario and a homogenous network slice scenario.

In some embodiments of the third aspect, the determining may include receiving a message from the communications network that the network slice is provided.

In some embodiments of the third aspect, the determining may include receiving a message from the communications network indicating to the user device to re-activate the data session.

In some embodiments of the third aspect, the message from the communications network may include information indicating to the user device to set-up a user device data radio bearer for the re-activated data session, wherein the method further comprises establishing a user device data radio bearer for the re-activated data session.

In some embodiments of the third aspect, the message from the communications network may be an RRC reconfiguration message.

In some embodiments of the third aspect, the determining may include detecting, by the user device, that the network slice is provided.

In some embodiments of the method according to the third aspect, the re-activating includes setting-up or activating a user device data radio bearer for the re-activated data session.

In some embodiments of the third aspect, the method may include that the first coverage area is a first tracking area, and/or the second coverage area is a second tracking area.

In some embodiments of the third aspect, the data session is a PDU session.

In some embodiments of the third aspect, the method may further comprise sending, to the network, a message indicating the change from the second coverage area to the first coverage area.

According to a fourth aspect of the subject disclosure, a method of operating a network device in a communications network is provided. The communications network comprises a first coverage area providing a network slice allowed for a user device and a second coverage area not providing the network slice. The method according to the fourth aspect may be performed by one or more network nodes. The method comprises: sending a message to the user device indicating a change from a second coverage area not providing a network slice allowed for the user device to a first coverage area providing the network slice, the message including information indicating to the user device to re-activate a data session with the network slice, from a user device data session context maintained at the user device, wherein the data session has been previously established for the network slice in the first coverage area or another coverage area providing the network slice allowed for the user device, receiving, from the user device, a message indicating the change from the second coverage area to the first coverage area.

In some embodiments of the fourth aspect, the method may be used to allow operating the user device in at least one registration area.

In some embodiments of the fourth aspect, the method may be used in at least one of non-homogenous network slice scenario and a homogenous network slice scenario.

In some embodiments of the fourth aspect, the first coverage area may be a first tracking area, and/or the second coverage area may be a second tracking area.

In some embodiments of the fourth aspect, the data session may be a PDU session.

In some embodiments of the method according to the fourth aspect, the method may further comprise re-activating a network slice data session maintained at the communications network, wherein the network slice data session has been previously established for the user device in the first coverage area or another coverage area providing the network slice.

In some embodiments of the method according to the fourth aspect, the method may further comprise setting-up a network data radio bearer related to the network slice data session.

In some embodiments of the method according to the fourth aspect, the method may further comprise sending buffered downlink data of the network slice, wherein the buffered downlink data is previously buffered downlink data of the network slice for the network slice data session which has been previously established for the user device for the network slice in the first coverage area or another coverage area providing the network slice allowed for the user device.

According to a fifth aspect of the subject disclosure, a user device is provided. The user device may comprise at least one processor; and at least one memory including computer program code. The computer program code causes the user device, when executed with the at least one processor, to at least: determine a change of the user device from a first coverage area providing a network slice allowed for the user device to a second coverage area not providing the network slice, suspend data transmission of a data session established in the first coverage area or another coverage area for the network slice, and maintain a user device data session context for the data session.

In some embodiments of the fifth aspect, the user device may be used in at least one registration area.

In some embodiments of the fifth aspect, the user device may be used in at least one of non-homogenous network slice scenario and a homogenous network slice scenario.

In some embodiments of the fifth aspect, the computer program code may cause the user device, when executed with the at least one processor, to perform at least one of the methods described above with respect to the user device changing from the first coverage area supporting the network slice to the second coverage area not supporting the network slice.

According to a sixth aspect of the subject disclosure, a user device is provided. The user device may comprise at least one processor; and at least one memory including computer program code. The computer program code causes the user device, when executed with the at least one processor, to at least: determine a change of the user device from a second coverage area not providing a network slice allowed for the user to a first coverage area providing the network slice, re-activate data transmission of a data session from a user device data session context maintained at the user device, wherein the data session has been previously established for the network slice in the first coverage area or another coverage area providing the network slice allowed for the user device.

In some embodiments of the sixth aspect, the user device may be used in at least one registration area.

In some embodiments of the sixth aspect, the user device may be used in at least one of non-homogenous network slice scenario and a homogenous network slice scenario.

In some embodiments of the sixth aspect, the computer program code may cause the user device, when executed with the at least one processor, to perform at least one of the methods described above with respect to the user device changing from a coverage area not providing a network slice allowed for the user device to a coverage area providing the network slice.

According to a seventh aspect of the subject disclosure, a network device in a network is provided. The network device comprises at least one processor; and at least one memory including computer program code. The computer program code causes the network device, when executed with the at least one processor, to at least: send a message to the user device indicating a change from a first coverage area providing a network slice allowed for the user device to the second coverage area not providing the network slice, the message including information indicating to the user device to suspend a data session established for the network slice, receive, from the user device, a message indicating the change from the first coverage area to the second coverage area.

In some embodiments of the seventh aspect, the network device may be used in at least one registration area.

In some embodiments of the seventh aspect, the network device may be used in at least one of non-homogenous network slice scenario and a homogenous network slice scenario.

In some embodiments of the seventh aspect, the computer program code may cause the user device, when executed with the at least one processor, to perform at least one of the methods described above with respect to a network device informing the user device to suspend the data session with the network slice.

According to an eight aspect of the subject disclosure, a network device in a network is provided. The network device comprises at least one processor; and at least one memory including computer program code. The computer program code causes the network device, when executed with the at least one processor, to at least: send a message to the user device indicating a change from a second coverage area not supporting a network slice allowed for the user device to the first coverage area supporting the network slice, the message including information indicating to the user device to re-activate a data session with the network slice, from a user device data session context maintained at the user device, wherein the data session has been previously established for the network slice in the first coverage area or another coverage area providing the network slice allowed for the user device, receive, from the user device, a message indicating the change from the second coverage area to the first coverage area.

In some embodiments of the eight aspect, the network device may be used in at least one registration area.

In some embodiments of the eight aspect, the network device may be used in at least one of non-homogenous network slice scenario and a homogenous network slice scenario.

In some embodiments of the eight aspect, the computer program code may cause the user device, when executed with the at least one processor, to perform at least one of the methods described above with respect to a network device informing the user device to re-activate the data session with the network slice.

According to a ninth aspect of the subject disclosure, a user device is provided. The user device comprises means of determining a change of the user device from a first coverage area providing a network slice allowed for the user device to a second coverage area not providing the network slice, means of suspending data transmission of a data session established in the first coverage area or another coverage area for the network slice, and means of maintaining a user device data session context for the data session.

In some embodiments of the ninth aspect, the user device may be used in at least one registration area.

In some embodiments of the ninth aspect, the user device may be used in at least one of non-homogenous network slice scenario and a homogenous network slice scenario.

In some embodiments of the ninth aspect, the computer program code may cause the user device, when executed with the at least one processor, to perform at least one of the methods described above with respect to the user device changing of the user device from the first coverage area providing the network slice to the second coverage area not providing the network slice.

According to a tenth aspect of the subject disclosure, a user device is provided. The user device comprises means of determining a change of the user device from a second coverage area not providing a network slice allowed for the user device to a first coverage area providing the network slice, means of re-activating data transmission of a data session from a user device data session context maintained at the user device, wherein the data session has been previously established for the network slice in the first coverage area or another coverage area providing the network slice allowed for the user device.

In some embodiments of the tenth aspect, the user device may be used in at least one registration area.

In some embodiments of the tenth aspect, the user device may be used in at least one of non-homogenous network slice scenario and a homogenous network slice scenario.

In some embodiments of the tenth aspect, the computer program code may cause the user device, when executed with the at least one processor, to perform at least one of the methods described above with respect to a user device changing from the second coverage area not providing a network slice allowed for the user device to the first coverage area providing the network slice.

According to an eleventh aspect of the subject disclosure, a network device in a network is provided. The network device comprises means of sending a message to the user device indicating a change from the a coverage area providing a network slice allowed for the user device to a second coverage area not providing the network slice, the message including information indicating to the user device to suspend a data session established for the network slice, means of receiving, from the user device, a message indicating the change from the first coverage area to the second coverage area.

In some embodiments of the eleventh aspect, the network device may be used in at least one registration area.

In some embodiments of the eleventh aspect, the network device may be used in at least one of non-homogenous network slice scenario and a homogenous network slice scenario.

In some embodiments of the eleventh aspect, the computer program code may cause the user device, when executed with the at least one processor, to perform at least one of the methods described above with respect to a network device informing the user device to suspend the data session established for the network slice.

According to a twelfth aspect of the subject disclosure, a network device in a network is provided. The network device comprises means of sending a message to the user device indicating a change from a second coverage area not supporting a network slice allowed for the user device to a first coverage area supporting the network slice, the message including information indicating to the user device to re-activate a data session with the network slice, from a user device data session context maintained at the user device, wherein the data session has been previously established for the network slice in the first coverage area or another coverage area providing the network slice allowed for the user device, means of receiving, from the user device, a message indicating the change from the second coverage area to the first coverage area.

In some embodiments of the twelfth aspect, the network device may be used in at least one registration area.

In some embodiments of the twelfth aspect, the network device may be used in at least one of non-homogenous network slice scenario and a homogenous network slice scenario.

In some embodiments of the twelfth aspect, the computer program code may cause the user device, when executed with the at least one processor, to perform at least one of the methods described above with respect to a network device informing the user device to re-activate the data session established for the network slice.

According to a thirteenth aspect of the subject disclosure, a non-transitory computer-readable medium containing computer-executable instructions which when run on one or more processors perform the steps according to any one of the embodiments of the methods outlined above.

The above-noted aspects and features may be implemented in systems, apparatuses, methods, articles and/or non-transitory computer-readable media depending on the desired configuration. The subject disclosure may be implemented in and/or used with a number of different types of devices, including but not limited to cellular phones, tablet computers, wearable computing devices, portable media players, and any of various other computing devices.

This summary is intended to provide a brief overview of some of the aspects and features according to the subject disclosure. Accordingly, it will be appreciated that the above-described features are merely examples and should not be construed to narrow the scope of the subject disclosure in any way. Other features, aspects, and advantages of the subject disclosure will become apparent from the following detailed description, drawings and claims.

### LIST OF ABBREVIATIONS

In the subject disclosure, the following abbreviations are used and should be understood in accordance with the given definitions:

| | |
|---|---|
| 3GPP | 3^{rd} Generation Partnership Project |
| 5G | 5^{th} Generation (Mobile Communication Network) |
| 5GC | 5G Core |
| 5GS | 5G System |
| AF | Application Function |
| AMF | Access and Mobility Function |
| AN | Access Network |
| APN | Access Point Name |
| BS | Base Station |
| CDMA | Code Division Multiple Access |
| CN | Core Network |
| CP | Control Plane |
| DNN | Data Network Name |
| eNB | Evolved NodeB |
| EPC | Evolved Packet Core |
| EPS | Evolved Packet System |
| ETSI | European Telecommunications Standards Institute |
| E-UTRAN | Evolved UMTS Terrestrial Radio Access |
| IE | Information Element |
| IMS | IP Multimedia Subsystem |
| IP | Internet Protocol |
| LTE | Long Term Evolution |
| MME | Mobility Management Entity |
| NAS | Non-Access Stratum |
| NR | New Radio |
| NSSAI | Network Slice Selection Assistance Information |
| PDN | Packet Data Network |
| PDP | Packet Data Protocol |
| PGW | PDN Gateway |
| PGW-C | PGW Control Function |
| PLMN | Public Land Mobile Network |
| RAN | Radio Access Network |
| RCS | Rich Communication Services |
| RRC | Radio Resource Control (Protocol) |
| SGW | Serving Gateway |
| SIM | Subscriber Identity Module |
| SMF | Session Management Function |
| S-NSSAI | Single NSSAI |
| TS | Technical Specification |
| UE | User Equipment |
| URLLC | Ultra-Reliable Low Latency Communication |
| VoNR | Voice over NR |

### BRIEF DESCRIPTION OF THE DRAWINGS

A better understanding of the subject disclosure can be obtained when the following detailed description of various embodiments is considered in conjunction with the following drawings, in which:

FIG. 1 shows a schematic diagram of an example communication system comprising a base station and a plurality of communication devices;

FIG. 2 shows a schematic diagram of an example mobile communication device;

FIG. 3 shows a schematic diagram of an example control apparatus;

FIG. 4 illustrates an example network slicing scenario;

FIG. 5 illustrates an example network slicing scenario;

FIG. 6 illustrates an example message sequence diagram for session management;

FIG. 7 illustrates an example message sequence diagram;

FIGS. 8 and 9 illustrate example flow charts of methods for session management; and

FIGS. 10 and 11 illustrate example flow charts of methods for session management.

### DETAILED DESCRIPTION

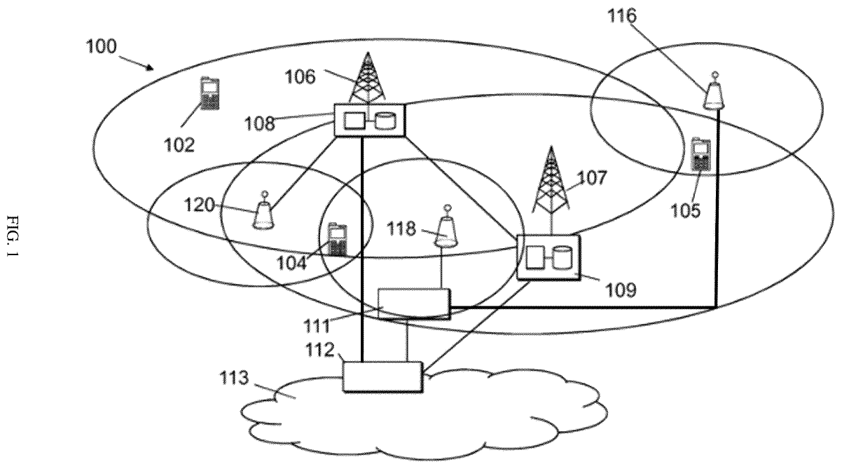

Before explaining the examples in detail, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices, user devices, user equipment (UE) 102, 104, 105 are provided wireless access via at least one base station (e.g., next generation NB, gNB), similar wireless transmitting and/or receiving node or network node. Base stations may be controlled or assisted by at least one appropriate controller apparatus, so as to enable operation thereof and management of mobile communication devices in communication with the base stations. The controller apparatus may be located in a radio access network (e.g., wireless communication system 100) or in a core network (CN) (not shown) and may be implemented as one central apparatus or its functionality may be distributed over several apparatuses. The controller apparatus may be part of the base station and/or provided by a separate entity such as a Radio Network Controller (RNC). In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

In FIG. 1, base stations 106 and 107 are shown as connected to a wider communications network 113 via gateway 112. A further gateway function may be provided to connect to another network.

As used herein, the term “base station” has the full breadth of its ordinary meaning, and at least includes a wireless communication station installed at a fixed location and used to communicate as part of a wireless telephone system or radio system. The communication area (or coverage area) of the base stations may be referred to as a “cell.” The base stations and the UEs may be configured to communicate over the transmission medium using any of various radio access technologies (RATs), also referred to as wireless communication technologies, or telecommunication standards described hereinbelow. As illustrated in FIG. 1, while one of the base stations may act as a “serving cell” for UEs, each UE may also be capable of receiving signals from (and possibly within communication range of) one or more other cells (which might be provided by the base stations and/or any other base stations), which may be referred to as “neighboring cells”.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example, wireless local area network (WLAN) and may be WLAN access points (Aps). The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long-term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE (LTE-A) employs a radio mobile architecture known as the Evolved Universal Terrestrial Radio Access Network (E-UTRAN) and a core network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as WLAN and/or Worldwide Interoperability for Microwave Access (WiMax). A base station can provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-A. Base stations of NR systems may be known as next generation Node Bs (gNBs). Changes to the network architecture may depend on the need to support various radio technologies and finer Quality of Service (QOS) support, and some on-demand requirements for e.g., QoS levels to support Quality of Experience (QoE) of user point of view. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent.

An example 5G core network (CN) comprises functional entities. The CN is connected to a UE via the radio access network (RAN). An UPF (User Plane Function) whose role is called PSA (PDU Session Anchor) may be responsible for forwarding frames back and forth between the DN (data network) and the one or more tunnels established over the 5G towards the UEs exchanging traffic with the data network (DN).

The UPF is controlled by an SMF (Session Management Function) that receives policies from a PCF (Policy Control Function). The CN may also include an AMF (Access & Mobility Function).

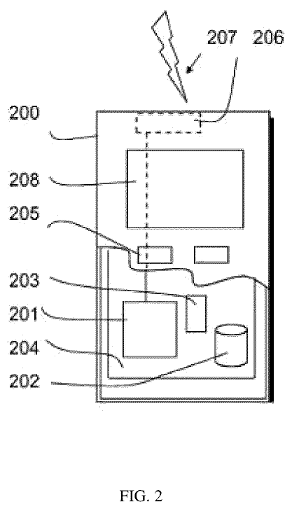

A possible (mobile) communication device 200 will now be described in more detail with reference to FIG. 2 showing a schematic, partially sectioned view. Such a mobile communication device 200 is often referred to as user equipment (UE), user device or terminal device. An appropriate mobile communication device 200 may be provided by any device capable of sending and receiving radio signals. Non-limiting examples comprise a mobile station (MS) or mobile device such as a mobile phone or what is known as a smart phone, a computer provided with a wireless interface card or other wireless interface facility (e.g., USB dongle), personal data assistant (PDA) or a tablet provided with wireless communication capabilities, or any combinations of these or the like. The communication device 200 may provide, for example, communication of data for carrying communications such as voice, electronic mail (e-mail), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

In an industrial application a communication device may be a modem integrated into an industrial actuator (e.g., a robot arm) and/or a modem acting as an Ethernet-hub that will act as a connection point for one or several connected Ethernet devices (which connection may be wired or unwired).

The communication device 200 is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets 204. The user may control the operation of the communication device 200 by means of a suitable user interface such as keypad 205, voice commands, touch sensitive screen or pad, combinations thereof or the like. A display 208, a speaker and a microphone can be also provided. Furthermore, the communication device 200 may comprise appropriate connectors (either wired or wireless) to other devices and/or for connecting external accessories, for example hands-free equipment, thereto.

The communication device 200 may receive signals over an air or radio interface 207 via appropriate apparatus for receiving and may transmit signals via appropriate apparatus for transmitting radio signals. In FIG. 2, transceiver apparatus is designated schematically by block 206. The transceiver apparatus 206 may be provided for example by means of a radio part and associated antenna arrangement. The antenna arrangement may be arranged internally or externally to the communication device 200.

The communication device 200 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Generally, the communication device 200 illustrated in FIG. 2 includes a set of components configured to perform core functions. For example, this set of components may be implemented as a system on chip (SoC), which may include portions for various purposes. Alternatively, this set of components may be implemented as separate components or groups of components for the various purposes. The set of components may be coupled (e.g., communicatively; directly or indirectly) to various other circuits of the communication device 200.

The communication device 200 may include at least one antenna in communication with a transmitter and a receiver (e.g., the transceiver apparatus 206). Alternatively, transmit and receive antennas may be separate. The communication device 200 may also include a processor (e.g., the at least one data processing entity 201) configured to provide signals to and receive signals from the transmitter and receiver, respectively, and to control the functioning of the communication device 200. The processor may be configured to control the functioning of the transmitter and receiver by effecting control signaling via electrical leads to the transmitter and receiver. Likewise, the processor may be configured to control other elements of the communication device 200 by effecting control signaling via electrical leads connecting processor to the other elements, such as a display (e.g., display 208) or a memory (e.g., the at least one memory 202). The processor may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, in some examples, the processor may comprise a plurality of processors or processing cores.

The communication device 200 may be capable of operating with one or more air interface standards, communication protocols, modulation types, access types, and/or the like. Signals sent and received by the processor may include signaling information in accordance with an air interface standard of an applicable cellular system, and/or any number of different wireline or wireless networking techniques, comprising but not limited to Wi-Fi, WLAN techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the communication device 200 and/or a cellular modem therein may be capable of operating in accordance with various third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like), or 5G beyond. For example, the communication device 200 may be capable of operating in accordance with 4G wireless communication protocols, such as LTE Advanced, 5G, and/or the like as well as similar wireless communication protocols that may be subsequently developed.

It is understood that the processor may include circuitry for implementing audio/video and logic functions of the communication device 200. For example, the processor may comprise a digital signal processor device, a microprocessor device, an analog-to-digital converter, a digital-to-analog converter, and/or the like. Control and signal processing functions of the communication device 200 may be allocated between these devices according to their respective capabilities. The processor may additionally comprise an internal voice coder (VC), an internal data modem (DM), and/or the like. Further, the processor may include functionality to operate one or more software programs, which may be stored in memory. In general, the processor and stored software instructions may be configured to cause the communication device 200 to perform actions. For example, the processor may be capable of operating a connectivity program, such as a web browser. The connectivity program may allow the communication device 200 to transmit and receive web content, such as location-based content, according to a protocol, such as wireless application protocol (WAP), hypertext transfer protocol (HTTP), and/or the like.

The communication device 200 may also comprise a user interface including, for example, an earphone or speaker, a ringer, a microphone, a display, a user input interface, and/or the like, which may be operationally coupled to the processor. The display may, as noted above, include a touch sensitive display, where a user may touch and/or gesture to make selections, enter values, and/or the like. The processor may also include user interface circuitry configured to control at least some functions of one or more elements of the user interface, such as the speaker, the ringer, the microphone, the display, and/or the like. The processor and/or user interface circuitry comprising the processor may be configured to control one or more functions of one or more elements of the user interface through computer program instructions, for example, software and/or firmware, stored on a memory accessible to the processor, for example, volatile memory, non-volatile memory, and/or the like. The communication device 200 may include a battery for powering various circuits related to the mobile terminal, for example, a circuit to provide mechanical vibration as a detectable output. The user input interface may comprise devices allowing the communication device 200 to receive data, such as a keypad (e.g., keypad 206) and/or other input devices. The keypad can also be a virtual keyboard presented on display or an externally coupled keyboard.

The communication device 200 may also include one or more mechanisms for sharing and/or obtaining data. For example, the communication device 200 may include a short-range radio frequency (RF) transceiver and/or interrogator, so data may be shared with and/or obtained from electronic devices in accordance with RF techniques. The communication device 200 may include other short-range transceivers, such as an infrared (IR) transceiver, a Bluetooth™ (BT) transceiver operating using Bluetooth™ wireless technology, a wireless universal serial bus (USB) transceiver, a Bluetooth™ Low Energy transceiver, a ZigBee transceiver, an ANT transceiver, a cellular device-to-device transceiver, a wireless local area link transceiver, and/or any other short-range radio technology. The communication device 200 and more specifically, the short-range transceiver may be capable of transmitting data to and/or receiving data from electronic devices within the proximity of the apparatus, such as within 10 meters, for example. The communication device 200 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The communication device 200 may comprise memory, such as one or more Subscriber Identity Modules (SIM), one or more Universal Subscriber Identity Modules (USIM), one or more removable User Identity Modules (R-UIM), one or more eUICC, one or more UICC, and/or the like, which may store information elements related to a mobile subscriber. In addition, the communication device 200 may include other removable and/or fixed memory. The communication device 200 may include volatile memory and/or non-volatile memory. For example, the volatile memory may include Random Access Memory (RAM) including dynamic and/or static RAM, on-chip or off-chip cache memory, and/or the like. The non-volatile memory, which may be embedded and/or removable, may include, for example, read-only memory, flash memory, magnetic storage devices, for example, hard disks, floppy disk drives, magnetic tape, optical disc drives and/or media, non-volatile random-access memory (NVRAM), and/or the like. Like volatile memory, the non-volatile memory may include a cache area for temporary storage of data. At least part of the volatile and/or non-volatile memory may be embedded in the processor. The memories may store one or more software programs, instructions, pieces of information, data, and/or the like which may be used by the apparatus for performing operations disclosed herein.

The memories may comprise an identifier, such as an International Mobile Equipment Identification (IMEI) code, capable of uniquely identifying the communication device 200. The memories may comprise an identifier, such as an international mobile equipment identification (IMEI) code, capable of uniquely identifying the communication device 200. In the example embodiment, the processor may be configured using computer code stored at memory to cause the processor to perform operations disclosed herein.

Some of the embodiments disclosed herein may be implemented in software, hardware, application logic, or a combination of software, hardware, and application logic. The software, application logic, and/or hardware may reside on the memory, the processor, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 2, computer-readable medium may comprise a non-transitory computer-readable storage medium that may be any media that can contain or store the instructions for use by or in connection with an instruction execution system, apparatus, or device, such as a computer.

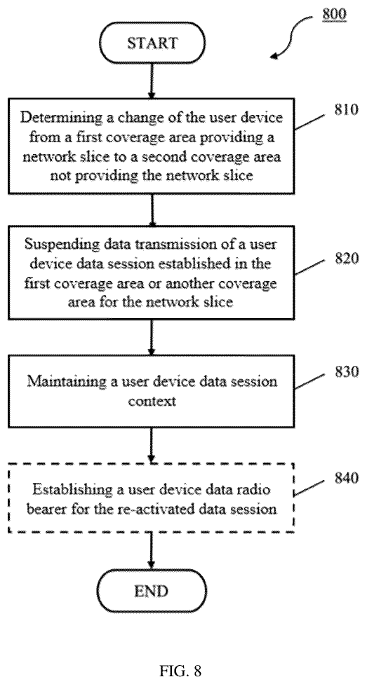

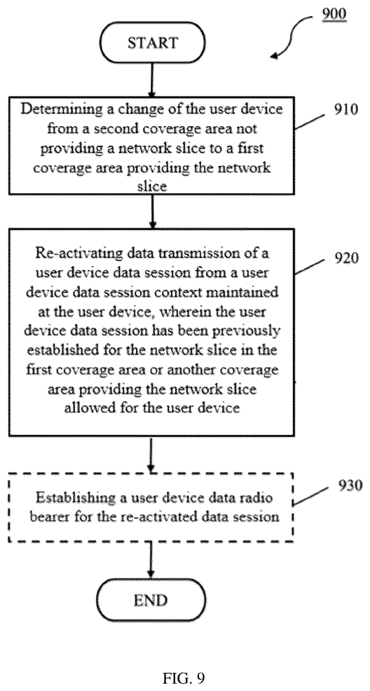

In some embodiments, the communication device 200 (i.e., a user equipment (UE) or a user device in a network) comprises the processor (e.g., the at least one data processing entity 201) and the memory (e.g., the at least one memory 202). The memory includes computer program code causing the communication device 200 to perform processing according to the methods described below with reference to FIG. 8 and FIG. 9.

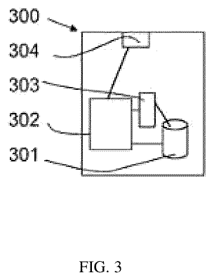

FIG. 3 shows an example embodiment of a control apparatus for a communication system, for example to be coupled to and/or for controlling a station of an access system, such as a RAN node, e.g., a base station, eNB or gNB, a relay node or a core network node such as an MME or S-GW or P-GW, or a core network function such as AMF/SMF, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

Generally, the control apparatus 300 has an antenna, which transmits and receives radio signals. A radio frequency (RF) transceiver module, coupled with the antenna, receives RF signals from antenna, converts them to baseband signals and sends them to processor (e.g., the at least one data processing unit 302, 303). RF transceiver also converts received baseband signals from processor, converts them to RF signals, and sends out to antenna. Processor processes the received baseband signals and invokes different functional modules to perform features in control apparatus 300. Memory (e.g., the at least one memory 301) stores program instructions and data to control the operations of the control apparatus 300. In the example of FIG. 3, the control apparatus 300 also includes protocol stack and a set of control functional modules and circuit. PDU session handling circuit handles PDU session establishment and modification procedures. Policy control module that configures policy rules for UEs. Configuration and control circuit provides different parameters to configure and control UEs of related functionalities including mobility management and session management. Suitable processors include, by way of example, a special purpose processor, a digital signal processor (DSP), a plurality of micro-processors, one or more micro-processor associated with a DSP core, a controller, a microcontroller, application specific integrated circuits (ASICs), file programmable gate array (FPGA) circuits, and other type of integrated circuits (ICs), and/or state machines.

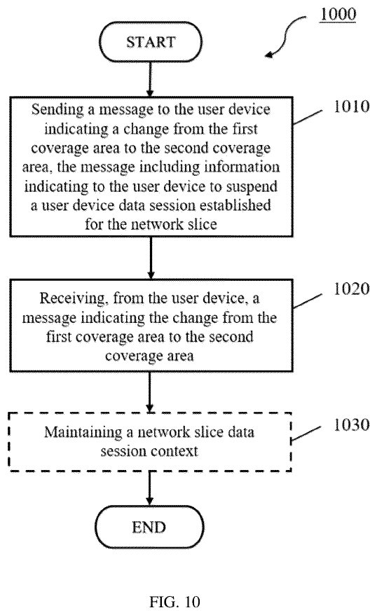

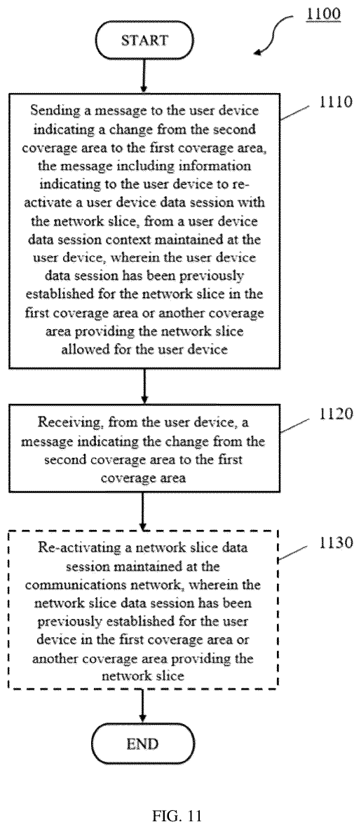

In some embodiments, the control apparatus 300 (i.e., a base station, a wireless transmitting and/or receiving point equipment, or a network node in a network) comprises the processor (e.g., the at least one data processing unit 302, 303) and the memory (e.g., the at least one memory 301). The memory includes computer program code causing the control apparatus 300 to perform processing according to the method described below with reference to FIG. 10 and FIG. 11.

As mentioned, network slicing is a concept where network resources of an end-to-end connection between a user device (i.e., a user equipment, UE) and another end point in a network such as a Public Land Mobile Network (PLMN) are sliced. Similar network slicing may be employed also in private networks. A network slice may be understood as a logical end-to-end network that can be dynamically created and/or modified. The network(s) between the end devices may all be sliced from one end device to the other end device, the slices thus forming logical pipelines within the network(s). User devices may access a slice over a radio interface. As described in 3GPP TS 38.300 (e.g., version 16.8.0 Release 16, 2022-01), network slicing will be a key feature in 5G to support different services using the same underlying mobile network infrastructure.

A slice may serve a particular service type. So far, three different network slice/service types have been standardized: cMBB (slice suitable for the handling of 5G enhanced Mobile Broadband), URLLC (slice suitable for the handling of Ultra-Reliable Low Latency Communication) and MIOT (slice suitable for the handling of massive Internet of Things). Communications Service Providers (CSPs) are able to define additional network slice/service types if needed. A given user device may access to multiple slices over the same Access Network (over the same radio interface, for example).

Thus, network slicing enables a communications service provider to provide dedicated virtual networks over a common network infrastructure. The different virtual or logical networks may be designed to provide different networking characteristics such as different qualities of service (QOS) in order to host services with diverse requirements and service level agreements (SLAs). For example, the virtual networks may be customized to meet specific needs of various applications, services, devices, customers and/or operators. Thus, the network slicing enables provision of different services to the terminal device. In an example, network slices may differ either in their service requirements like URLLC and eMBB or the tenant that provides those services.

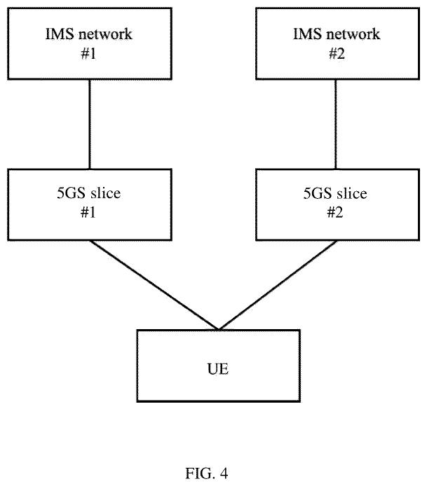

An illustration of a scenario in which a user device (i.e., the UE) uses two different services provided by two different networks (e.g., IMS networks) is provided by FIG. 4. In this scenario, the UE is connected through two different network slices (e.g., 5GS network slices) to the IMS networks. That is, the UE is connected through 5GS slice #1 to the IMS network #1 and uses a service provided by the IMS network #1 (e.g., RCS). The UE is also connected through 5GS slice #2 to the IMS network #2 and uses a service provided by the IMS network #2 (e.g., VoNG). This allows to customize the network slices for the different services hosted by each of the IMS networks. The IMS networks #1 and #2 are depicted by way of example and are optional.

A network slice is uniquely identified via the Single-Network Slice Selection Assistance Information (S-NSSAI). Current 3GPP specifications (e.g., 3GPP TS 38.300 version 16.8.0 Release 16, 2022-01) allow a user device to be simultaneously connected and served by at most eight network slices corresponding to eight S-NSSAIs. On other hand, each cell may support tens or even hundreds of S-NSSAIs. In current 3GPP specifications (e.g., 3GPP TS 38.423 version 16.8.0 Release 16, 2022-01), a tracking area (TA) can have a support up to 1024 network slices.

The format of the S-NSSAI may include both Slice Service Type (SST) and Slice Differentiator (SD) fields with a total length of 32 bits or include only SST field part in which case the length of S-NSSAI is 8 bits only. Examples of the format are described in 3GPP specifications such as 3GPP TS 23.501 or 3GPP TS 23.003. The SST field may have standardized and non-standardized values. Values 0 to 127 belong to the standardized SST range. For instance, SST value of 1 may indicate that the slice is suitable for handling of 5G cMBB, 2 for handling of URLLC, etc. SD is operator-defined only.

Other concepts concern defining a tracking area (TA) and a registration area (RA). The TA is a logical concept of an area where a user can move around without updating the MME and is the LTE, EPS or 5GS counterpart of the location area and routing area of GSM, WCDMA and GPRS. The TA consists of a set of cells. TAs can be grouped into lists of tracking areas (TA lists), which can be configured on the UE. For example, the network allocates a list with one or more TAs to the user. In certain operations, the UE may move freely in all TAs of the list without updating the MME. The RA is a list consisting of tracking areas (TAs), which is configured to the UE by the network. The RA are used to track the UE for paging purposes. If the UE leaves the RA, the UE will let the network know through NAS registration request (referred to as mobility registration update) such that the correct RA can be configured to the UE.

In 5G, the RA also has the role to maintain allowed slices (alternatively allowed NSSAI) of the UE. The allowed NSSAI is configured to the UE by the network. Throughout the subject disclosure, an allowed S-NSSAI can refer to an S-NSSAI included in the allowed NSSAI. The UE NAS can request access to an S-NSSAI and the network would decide to add that S-NSSAI to the UE's list or not.

In recent developments, agreement to have homogenous slice support within a TA, as well as RA, was achieved. This means that the same slices are to be supported throughout a TA, and the allowed NSSAI is valid throughout the RA of the UE.

However, the RA may comprise multiple TAs that are not supporting all allowed slices of the UE, allowing a more flexible registration area configuration including non-homogenous slice support for the TAs comprising the RA.

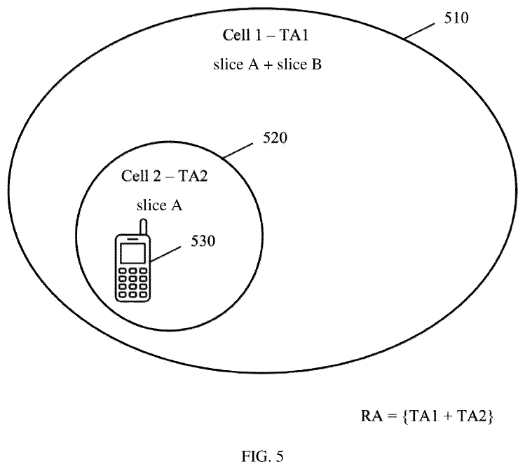

FIG. 5 illustrates an example network slice scenario.

In the example scenario, the user device (e.g., UE) 530 is configured with a registration area (RA) that comprises two tracking areas such as a first tracking area (TA1) 510 and a second tracking area (TA2) 520. That is, RA is defined as RA={TA1+TA2}. In FIG. 5, the first tracking area (TA1) corresponds to a first cell (cell 1) and the second tracking area (TA2) corresponds to a second cell (cell 2). Cell 1 and cell 2 may belong to one or two network nodes like e.g., a gNB.

In the first tracking area (TA1) or the first cell (cell 1), two network slices, slice A and slice B, are configured. One of these two network slices provides a first service such as eMBB while the other provides a second service such as URLLC. In the second tracking area (TA2) or the second cell (cell 2), only on network slice, slice A, providing the first service such as cMBB is configured.

The UE 530 has the slices, slice A and slice B, providing the first (cMBB) and second (URLLC) service as allowed slices.

In the example scenario shown in FIG. 5, the UE 530 is assumed to be camping on the second cell (cell 2) in the second tracking area (TA2) and thus is enabled to use the first service (cMBB).

When the UE 530 is being paged for a PDU session of the second service (URLLC), the network (e.g., AMF) sends a message to the first cell (cell 1) which supports the second service (URLLC) and possibly to other cells of the first tracking area (TA1). The UE 530 is however not camping on the first cell (cell 1) and the paging message can therefore not be received by the UE 530.

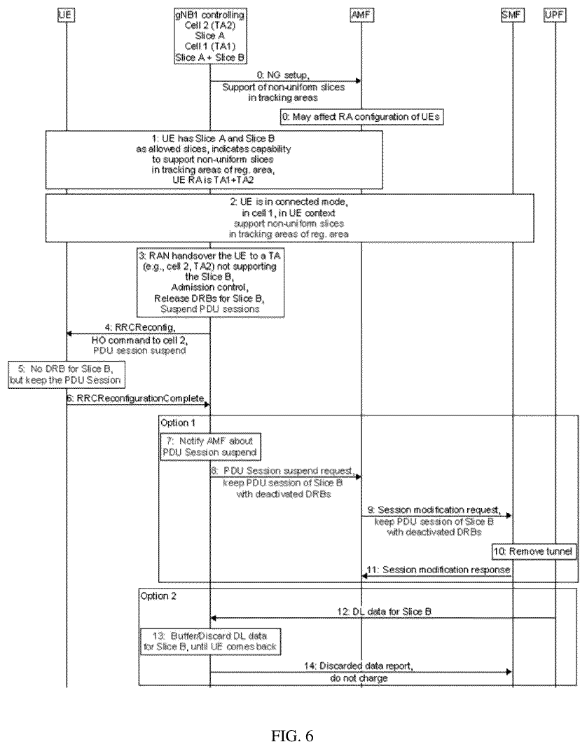

In FIG. 6, a message sequence diagram for session management is illustrated. The message sequence diagram illustrates the messages exchanged between, and operations performed by, user devices/network nodes of a network similar to the example scenario illustrated in FIG. 5.

The network of FIG. 6 may comprise one or more network nodes (e.g., one or more base stations and one or more control functions) and at least one user equipment (UE). The network comprises two cells, including a first cell (cell 1) and a second cell (cell 2). In the network, a first tracking area (TA1) comprising the first cell (cell 1) and a second tracking area (TA2) comprising the second cell (cell 2) is defined. The cells (or tracking areas) are each controlled or served by one base station gNB1. The network further comprises core network functions such as AMF, SMF and UPF. In the network, network slices are configured. The network slices comprise a network slice configured in the first cell (cell 1) and providing slice A and slice B. Network slice A is configured in the second cell (cell 2). The network slices may be configured in the network for providing e.g., cMBB and URLLC services. Here, the first cell (cell 1) may provide cMBB and URLLC services to UEs camping on the first cell (cell 1). On the other hand, the second cell (cell 2) may provide the cMBB slice and eMBB services to UEs camping on the second cell (cell 2).

This session management of a user device as shown in FIG. 6 proposes a method for correct mobile originated (MO) data request in connected mode in a scenario where there is non-homogenous slice support for the TAs comprising the RA (Registration Area of the UE). In this scenario, losing slice support due to moving to a cell (cell 2) that doesn't support the allowed slice of the UE corresponding to an ongoing Protocol Data Unit (PDU) session. The loss of slice support doesn't affect the registration area or the list of allowed slices for the UE due to non-homogenous slice support in the registration area.

A PDU session provides end-to-end user plane connectivity between the UE and a specific Data Network (DN) through the User Plane Function (UPF). A PDU session supports one or more Quality of Service (QOS) flows.

Besides the already mentioned slices eMBB and URLLC further slices like e.g., MIoT or V2X or dynamic slices are encompassed.

FIG. 6 shows mobility of a UE which is CM-CONNECTED with RA=TAI, TAI2 with Allowed NSSAI S-NSSAI1 (Slice A) and Partially allowed S-NSSAI (Slice B) in TAI1 S-NSSAI1 where the TAI1 and TAI2 are supported by cells under gNB1, and where the UE has PDU sessions activated for both S-NSSAI1 and S-NSSAI2. Upon mobility to TAI2, the PDU session(s) for S-NSSAI2 are deactivated, meaning at least the context is preserved but the DL data is dropped and is not accounted for. The related DRBs are also reconfigured to be deactivated during the HO. The trigger for deactivation at AMF may be reception of a Path switch indicating S-NSSAI2 is now not supported which may be explicitly indicated or the ULI allows the AMF to detect that situation (Option 1).

Upon mobility to TAI2 (Option 2) the DL for the PDU session(s) for S-NSSAI2 data is dropped in the RAN. The related DRBs are also reconfigured to be deactivated during the HO. Since there is DL dropped data at the RAN, this data is accounted for so a report of the dropped data volume may need to be sent periodically and when the AN connection is released as per configuration in the RAN. This may be sent to HPLMN SMF based on a roaming agreement. The activation/deactivation of sessions may be a local event in the RAN based on the TA where the UE is. RRC inactive may be enabled or RCC may be deactivated. This option of the one requiring end to end modification of the state of PDU sessions may be used.

At step 0 of FIG. 6, the gNB1 sets up the AMF especially support of non-uniform slices in tracking areas. Such setup may affect RA configuration at the AMF for UEs. The UE has connected DRBs and data or PDU sessions for both S-NSSAI slices. It is also possible, to only have a single slice connection or a connection to more than two slices.

As shown in step 1 of FIG. 6, the UE has slice A and slice B as allowed slices and indicates its capability to support non-uniform slices in tracking areas of the registration area. Further, the registration area (RA) comprising the first and second tracking areas (TAI and TA2) is configured to the UE.

Further, as shown in step 2 of FIG. 6, the UE is in connected mode in cell 1. Support of non-uniform slices in tracking areas of the registration area is registered in the UE context.

At step 3, in the network, RAN hands over the UE to TA not supporting slice B, like TA2 of cell 2. Admission control at gNB releases DRBs for slice B and suspends the corresponding PDU sessions and/or releases any PDU session context. PDU session related context is kept at gNB1 for a possible re-activation of the session.

As a consequence, to step 4, gNB sends an RRC Reconfig message towards the UE at step 4. This message includes a hand over (HO) command to cell 2 as well as an order to or information about suspension of the PDU session.

In response to receiving the RRC Reconfig message from the gNB, the UE either releases the data radio bearers (DRB) s or deactivates them at step 5. The UE does not release the PDU Session even if there will be no DRBs related to that PDU Session and will consider this PDU Session de-activated.

After completion, at step 6, the UE messages an RRC Reconfiguration Complete message to the gNB.

In response to the RRC Reconfiguration Complete message, two options for the network side are discussed below.

On the network side, as option 1, the PDU Session is de-activated at the Session Management Function (SMF), or as option 2, PDU session data is buffered at the RAN node, here gNB1.

At step 7, as the first step of option 1, gNB1 notifies the AMF on the suspension of the PDU session. To that end, at step 8, gNB 1 sends a PDU session suspend request to the Access and Mobility Management Function (AMF). This request includes to keep or maintain the PDU session of slice B with deactivated DRBs.

At step 9, the AMF forwards the PDU session suspend request to the SMF. These messages may be NGAP messages. In particular, a path switch request in an inter-gNB scenario or a new NGAP message in an intra-gNB scenario.

At step 10, the SMF contacts the User Plane Function (UPF) to inform that the PDU session is de-activated. Further, the SMF releases or removes a tunnel to the UPF. Such a tunnel may by a N3 tunnel. Further, data session context for the network slice may be maintained while the user device is in the second coverage area. The data session context for the network slice may include information regarding the link of DRB and the (N3) tunnel. It is possible to retain the (N3) tunnel while deactivating the DRB.

Following at step 11, the SMF replies with a session modification response message to the AMF indicating that the tunnel has been removed.

At step 12, as the first step of option 2, the UPF sends the DL data for slice B to the gNB1. The gNB1 buffers the DL data for the PDU session at step 13. The DL data may be buffered until the UE returns to the cell or TA of the gNB1. Additionally, or alternatively, the DL data may be buffered until a timer expires. In this option, the core network is unaware of the de-activated state of the PDU Session at the UE side.

At step 14, in order to treat charging correctly, the SMF may be reported from the gNB1 about the buffered and/or discarded data at the RAN node.

Such buffered and/or discarded data are not provided to the UE. Therefore, they may be excluded from charging. To this end, a message, for example send from the gNB1 to the SMF, may be used to indicate that buffered and/or discarded data are to be excluded from charging. The network device may indicate the amount of discarded data to the communications network. The amount of discarded data may be related to lack of service support due to not providing the network slice. The amount of discarded data may be indicated to the core network especially to the charging calculating entity for charging purposes.

As the UE does not release, i.e., maintains, the PDU Session it is not required that the UE needs to generate more signaling in terms of a PDU session establishment procedure to request the connectivity again when a network slice is supported in the next cell the UE is moving under coverage.

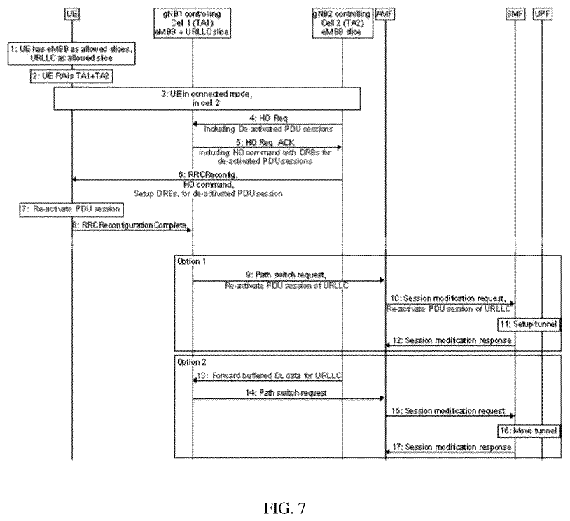

In FIG. 7, a message sequence diagram for session management is illustrated. The message sequence diagram illustrates the messages exchanged between, and operations performed by, user devices/network nodes of a network similar to the example scenario illustrated in FIG. 5.

Session management of a user device, as depicted in FIG. 7, concerns gaining slice support due to moving to a cell that does support the allowed slice of the UE from a cell that doesn't support the allowed slice of the UE.

FIG. 7 shows mobility of a UE which is CM-CONNECTED with RA=TAI, TAI2 with Allowed NSSAI S-NSSAI1 and Partially allowed S-NSSAI in TAI2 S-NSSAI2 where the TAIL and TAI2 are supported by cells under different gNBs, and where the UE has PDU sessions activated for S-NSSAI1 and deactivated for S-NSSAI2.

Upon mobility to TAI1, the PDU session(s) for S-NSSAI2 are reactivated, meaning the context now set in SMF/UPF to enable data forwarding for the PDUs sessions for S-NSSAI2. The related DRBs are also reconfigured to be activated during the HO. The trigger for reactivation at AMF may be the reception of a Path switch indicating S-NSSAI2 is now supported which may be explicitly indicated, or the ULI allows the AMF to detect that situation (Option 1). The trigger for reactivation at AMF may be the reception of an NG-AP message indicating S-NSSAI2 is now supported (Option 2).

The network of FIG. 7 may comprise one or more network nodes (e.g., one or more base stations and one or more control functions), here gNB1 and gNB2, and at least one user equipment (UE). The network comprises two cells, including a first cell (cell 1) and a second cell (cell 2). The first cell is controlled by gNB1 while the second cell is controlled by gNB2. In the network, a first tracking area (TA1) comprising the first cell (cell 1) and a second tracking area (TA2) comprising the second cell (cell 2) is defined. The network further comprises core network functions such as AMF, SMF and UPF. In the network, network slices are configured. The network slices comprise network slices configured in the first cell (cell 1) and in the second cell (cell 2). The network slices may be configured in the network for providing in TAI or in the first cell services e.g., cMBB and URLLC services. On the other hand, TA2 or the second cell (cell 2) may provide the MBB slice services to UEs camping on the second cell (cell 2).

At step 1 of FIG. 7 is indicated that the UE has eMBB and URLLC as allowed slices.

At step 2 of FIG. 7 is indicated the registration area (RA) comprising the first and second tracking areas (TAI and TA2) is configured to the UE.

Further, as shown in step 3 of FIG. 7, the UE is in connected mode in cell 2 or TA2 of gNB2.

At step 4 of FIG. 7, gNB2 which is controlling cell 2 and TA2 sends a HO request message to gNB1 which is controlling cell 1 and TA1. This message includes as well information about deactivation or suspension of PDU sessions of the UE. The deactivated PDU sessions include one or more sessions which are not supported by TA2 or cell 2 of gNB2 and which have been active with the UE in a prior cell or prior TA. The prior cell or prior TA may be gNB1 or a further network node supporting for example URLLC or even further services.

At step 5 of FIG. 7, gNB1 issues a HO request acknowledged message to gNB2 including a HO command with DRBs corresponding to deactivated PDU sessions.

The DRBs and/or the deactivated PDU sessions may be supported by gNB1, like URLLC in this example.

At step 6 of FIG. 7, gNB2 sends an RRC Reconfig message towards the UE. This message includes a hand over (HO) command to cell 1 as well as DRB setup information for corresponding deactivated PDU sessions.

At step 7 of FIG. 7, the UE re-activates the one or more PDU sessions which have been previously, i.e., before or at signing in into TA2 or cell 2, deactivated. Such re-activation requires only the setup of the DRB as the deactivated PDU session has been kept active or maintained at the UE. In other words, the PDU session has only been deactivated globally or at the network side while it had been kept at the UE, however with deactivated DRBs. Thus, one can say that at step 7, at the UE, only the DRB corresponding to the deactivated PDU session are re-activated.

After completion, at step 8, the UE messages an RRC Reconfiguration Complete message to the gNB1.

In response to the RRC Reconfiguration Complete message, two options for the network side are discussed below.

On the network side, as option 1, the PDU session is re-activated at the SMF or, as option 2, the buffered DL data of the PDU session at the gNB2 is forwarded to the gNB1 that supports the allowed slice of the UE.

At step 9, as the first step of option 1, gNB1 issues a path switch request message to the AMF including a command or notifier to re-activate the PDU session of URLLC. This message may be an NGAP message. Further, this message may be or include a path switch request in inter-gNB scenario or a new NGAP message in intra-gNB scenario.

At step 10, AMF issues a session modification request message to the SMF in reaction to the path switch request message received from gNB1 including the command or notifier to re-activate the PDU session of URLLC.

At step 11, SMF sets up a tunnel to the UPF in reaction to receiving the session modification request message. Following at step 12, the SMF replies with a session modification response message to the AMF indicating that the tunnel has been setup.

At step 13, as the first step of option 2, gNB2 forwards buffered DL data for a URLLC session that had been had been active with the UE and then deactivated to gNB1.

At step 14, after receiving the data, gNB1 issues a path switch request message to the AMF.

At step 15, AMF issues a session modification request message to the SMF in reaction to the path switch request message received from gNB1.

At step 16, in reaction to receiving the session modification request message, SMF moves a tunnel to the UPF which is corresponding to the session. Following at step 17, the SMF replies with a session modification response message to the AMF indicating that the tunnel has been moved.

Option 1 of FIG. 7 corresponds to option 1 of FIG. 6, in that the de-activation of the PDU session is indicated to the network side, especially the SMF. Accordingly, the tunnel is removed when the UE loses slice support (FIG. 6) and setup again once the UE gains slice support (FIG. 7).

Similar, option 2 of FIG. 7 corresponds to option 2 of FIG. 6, in that the de-activation of the PDU session is not indicated to the network side. Accordingly, the DL data is buffered when the UE loses slice support (FIG. 6) and the DL data and the tunnel are moved when the UE gains slice support again (FIG. 7).

FIG. 8 illustrates a flow chart of a method of operating a user device in a network. The method depicted in FIG. 8 illustrates suspending of data transmission of a data session.

The method is performed by a user device (also referred to as a user equipment (UE)), or an apparatus for use in a user device. For example, the UE may be represented by any one of the mobile communication devices 102, 104, 105 of the wireless communication system 100 as described above with reference to FIG. 1, or the communication device 200 as described above with reference to FIG. 2.

In an example, the network may comprise at least two cells, including a first cell and a second cell. Each cell corresponds to or belongs to a tracking area. For example, in the network, a first tracking area comprises the first cell and a second tracking area comprises the second cell. The first cell and the second cell (or tracking areas) are each controlled or served by a base station. A first base station controls the first cell and/or the first tracking area, while a second base station controls the second cell and/or the second tracking area. Alternatively, a single base station like e.g., a gNB controls the cells and/or tracking areas. The network further comprises a core network function.

In the network, the concept of network slicing is established. The network slices configured in the network may comprise a first slice configured in both cells (i.e., the first cell and the second cell) and providing a first service, a second slice configured in the first cell and providing a second service, and a third slice configured in the second cell and providing a third service.

The UE may be camping on one of the cells (e.g., the first cell) of the network and the first slice and the second slice may be configured as allowed slices for the UE. That is, the UE is allowed to use the services of the first slice and the second slice. The first and second tracking areas may be configured to the UE and a registration area comprising the first and second tracking areas may be configured to the UE by the network.

At block 810, the UE determines a change of the user device from a first coverage area providing a network slice allowed for the user device to a second coverage area not providing the network slice. The first coverage area may correspond to the first tracking area and/or the first cell while the second coverage area may correspond to the second tracking area and/or the second cell. The determination by the UE may include receiving a message from the communications network. Such message may include an indication that the network slice is not provided, that a change of the user device from the second coverage area to the first coverage area was or will be taken, and/or that the user device is to suspend the data session. The message from the communications network may be an RRC reconfiguration message. Such message may further include that DRBs corresponding to the network slice are no longer used for UL. Receiving an explicit indication from the RAN, i.e., the message as indicated above, whether a slice or service is supported may enhance consistence between RAN and UE. The RAN may know from the cell ID, etc. whether a coverage area provides the network slice.

As an alternative to the message from the communications network, the user device or UE may detect that the network slice is not provided by the second coverage area.

At block 820, the UE suspends data transmission of a data session established in the first coverage area or another coverage area for the network slice. The suspending may include releasing a user device data radio bearer related to the data session or deactivating the user device data radio bearer. In other words, the UE suspends or blocks UL/DL data. The UE is still in connected mode but without DRB for this network slice or slices of the data session.

At block 830, the UE maintains a user device data session context for the data session. As such, at least the context of the data session, such as a PDU session, is kept or stored at the UE. The maintained session context may include information like a session ID, an IP or protocol configuration for restarting the session, a state of the session and the like. Further, maintaining the user device data session context or the data session may include storing or buffering data from the data session like e.g., UL data. The maintaining may include that the UE maintains the data session at a non-access stratum and suspends the data session at an access stratum. Thus, when the UE behavior doesn't receive a radio bearer for the data session it does not terminate the data session but maintains at least the user device data session context.

In some examples, the method 800 may further comprise, at block 840, deactivating a user device data radio bearer related to the data session. Such step may include that the UE releases a user device data radio bearer related to the data session or deactivating the user device data radio bearer. The deactivating may affect one or more user device data radio bearers.

FIG. 9 illustrates a flow chart of a method of operating a user device in a network. The method depicted in FIG. 9 illustrates re-activating data transmission of a data session.

The method is performed by a user device (also referred to as a user equipment (UE)), or an apparatus for use in a user device. For example, the UE may be represented by any one of the mobile communication devices 102, 104, 105 of the wireless communication system 100 as described above with reference to FIG. 1, or the communication device 200 as described above with reference to FIG. 2.

In an example, the network may comprise at least two cells, including a first cell and a second cell. Each cell corresponds to or belongs to a tracking area. For example, in the network, a first tracking area comprises the first cell and a second tracking area comprises the second cell. The first cell and the second cell (or tracking areas) are each controlled or served by a base station. A first base station controls the first cell and/or the first tracking area, while a second base station controls the second cell and/or the second tracking area. Alternatively, a single base station like e.g., a gNB controls the cells and/or tracking areas. The network further comprises a core network function.

In the network, the concept of network slicing is established. The network slices configured in the network may comprise a first slice configured in both cells (i.e., the first cell and the second cell) and providing a first service, a second slice configured in the first cell and providing a second service, and a third slice configured in the second cell and providing a third service.

The UE may be camping on one of the cells (e.g., the second cell) of the network and the second slice may be configured as allowed slices for the UE. That is, the UE is allowed to use the services of the second slice only. The first and second tracking areas may be configured to the UE and a registration area comprising the first and second tracking areas may be configured to the UE by the network. The first cell of the network allows or provides the first slice and the second slice.

At block 910, the UE determines a change of the user device from a second coverage area not providing a network slice allowed for the user device to a first coverage area providing the network slice. The first coverage area may correspond to the first tracking area and/or the first cell while the second coverage area may correspond to the second tracking area and/or the second cell. Here, UE movement is opposite to UE movement of FIG. 8. Thus, the method shown in FIG. 9 may follow to the method shown in FIG. 8. Further, the data session for the network slice may be established in the first coverage area or another coverage area in which the UE was located before entering the first coverage area.

The determination by the UE may include receiving a message from the communications network. Such message may include an indication that the network slice is not provided, that a change of the user device from the second coverage area to the first coverage area was or will be taken, and/or that the user device is to suspend the data session. The message from the communications network may be an RRC reconfiguration message. Such message may further include that DRBs corresponding to the network slice are no longer used for UL. Receiving an explicit indication from the RAN, i.e., the message as indicated above, whether a slice or service is supported may enhance consistence between RAN and UE. The RAN may know from the cell ID, etc. whether a coverage area provides the network slice.

As an alternative to the message from the communications network, the user device or UE may detect that the network slice is not provided by the second coverage area.

At block 920, the UE re-activates data transmission of a data session from a user device data session context maintained at the user device. This data session has been previously established for the network slice in the first coverage area or another coverage area providing the network slice allowed for the user device. Such step may include that the UE sets up or activates a user device data radio bearer related to the data session. The re-activating may affect one or more user device data radio bearers.

At least the context of the data session, such as a PDU session, has been maintained or stored at the UE. The maintained session context may include information like a session ID, an IP or protocol configuration for restarting the session, a state of the session and the like. Further, maintaining the user device data session context or the data session may include storing or buffering data from the data session like e.g., UL data. The maintaining may include that the UE maintains the data session at a non-access stratum and suspends the data session at an access stratum.

In some examples, the method 900 may further comprise, at block 930, establishing a user device data radio bearer for the re-activated data session. The establishing may affect one or more user device data radio bearers.

FIG. 10 illustrates a flow chart of a method of operating a network device in a communications network. The method depicted in FIG. 10 illustrates suspending or suspending of data transmission of a data session.

The method is performed by the network. More specifically, the method may be performed by one or more network nodes or network functions of the network, or an apparatus for use in a network node or by a network function. For example, the method may be performed by a base station such as the base station represented by the control apparatus 300 as described above with reference to FIG. 3, and/or a core network function such as AMF. Examples of the network node/device or network function may be the gNB1 and/or the AMF in FIGS. 6 and 7.

In an example, the network may comprise at least two cells, including a first cell and a second cell. Each cell corresponds to or belongs to a tracking area. For example, in the network, a first tracking area comprises the first cell and a second tracking area comprises the second cell. The first cell and the second cell (or tracking areas) are each controlled or served by a base station. A first base station controls the first cell and/or the first tracking area, while a second base station controls the second cell and/or the second tracking area. Alternatively, a single base station like e.g., a gNB controls the cells and/or tracking areas. The network further comprises a core network function.

In the network, the concept of network slicing is established. The network slices configured in the network may comprise a first slice configured in both cells (i.e., the first cell and the second cell) and providing a first service, a second slice configured in the first cell and providing a second service, and a third slice configured in the second cell and providing a third service.

The UE may be camping on one of the cells (e.g., the first cell) of the network and the first slice and the second slice may be configured as allowed slices for the UE. That is, the UE is allowed to use the services of the first slice and the second slice. The first and second tracking areas may be configured to the UE and a registration area comprising the first and second tracking areas may be configured to the UE by the network.

At block 1010, the network sends a message to the user device or UE indicating a change from a first coverage area providing a network slice allowed for the user device to a second coverage area not providing the network slice, the message including information indicating to the user device to suspend a data session established for the network slice not provided in the second coverage area. This message may be sent after the network determines a change of the user device from a first coverage area providing a network slice allowed for the user device to a second coverage area not providing the network slice.

The first coverage area may correspond to the first tracking area and/or the first cell while the second coverage area may correspond to the second tracking area and/or the second cell. The message may include an indication that the network slice is not provided, that a change of the user device from the second coverage area to the first coverage area was or will be taken, and/or that the user device is to suspend the data session. The message from the communications network may be an RRC reconfiguration message. Such message may further include that DRBs corresponding to the network slice are no longer used for UL. Receiving an explicit indication from the RAN, i.e., the message as indicated above, whether a slice or service is supported may enhance consistence between RAN and UE. The RAN may know from the cell ID, etc. whether a coverage area provides the network slice.

At block 1020, the network receives from the user device a message indicating the change from the first coverage area to the second coverage area. The message from the UE may indicate that the UE has suspend data transmission of a data session established in the first coverage area or another coverage area for the network slice. The suspending may include releasing a user device data radio bearer related to the data session or deactivating the user device data radio bearer. In other words, the UE suspends or blocks UL/DL data. The UE is still in connected mode but without DRB for this network slice or slices of the data session.

In some examples, the method 1000 may further comprise, at block 1030, the network maintains a network device data session context for the data session. As such, at least the context of the data session corresponding to the network slice, such as a PDU session, is kept or stored at the network. The maintained session context may include information like a session ID, an IP or protocol configuration for restarting the session, a state of the session and the like. Further, maintaining the network device data session context or the data session may include storing or buffering data from the data session like e.g., DL data. The maintaining may include to inform AMF, SMF and/or further network functions. The maintaining may also include to block DL.

In some examples, the method 1000 may further comprise deactivating a data radio bearer related to the data session. Such step may include that the network releases a data radio bearer related to the data session or deactivating the data radio bearer. The deactivating may affect one or more data radio bearers.

FIG. 11 illustrates a flow chart of a method of operating a communications network. The method depicted in FIG. 11 illustrates re-activating data transmission of a data session.

The method is performed by the network. More specifically, the method may be performed by one or more network nodes or network functions of the network, or an apparatus for use in a network node or by a network function. For example, the method may be performed by a base station such as the base station represented by the control apparatus 300 as described above with reference to FIG. 3, and/or a core network function such as AMF.

In an example, the network may comprise at least two cells, including a first cell and a second cell. Each cell corresponds to or belongs to a tracking area. For example, in the network, a first tracking area comprises the first cell and a second tracking area comprises the second cell. The first cell and the second cell (or tracking areas) are each controlled or served by a base station. A first base station controls the first cell and/or the first tracking area, while a second base station controls the second cell and/or the second tracking area. Alternatively, a single base station like e.g., a gNB controls the cells and/or tracking areas. The network further comprises a core network function.

In the network, the concept of network slicing is established. The network slices configured in the network may comprise a first slice configured in both cells (i.e., the first cell and the second cell) and providing a first service, a second slice configured in the first cell and providing a second service, and a third slice configured in the second cell and providing a third service.

The UE may be camping on one of the cells (e.g., the second cell) of the network and the second slice may be configured as allowed slices for the UE. That is, the UE is allowed to use the services of the second slice only. The first and second tracking areas may be configured to the UE and a registration area comprising the first and second tracking areas may be configured to the UE by the network. The first cell of the network allows or provides the first slice and the second slice.

At block 1110, the network sends a message to the user device indicating a change from a second coverage area not providing a network slice allowed for the user device to a first coverage area providing the network slice, the message including information indicating to the user device or UE to re-activate a data session with the network slice, from a user device data session context maintained at the user device, wherein the data session has been previously established for the network slice in the first coverage area or another coverage area providing the network slice allowed for the user device. This message may be sent after the network determines a change of the user device from a first coverage area providing a network slice allowed for the user device to a second coverage area not providing the network slice.

The first coverage area may correspond to the first tracking area and/or the first cell while the second coverage area may correspond to the second tracking area and/or the second cell. The message may include an indication that the network slice is provided and/or that a change of the user device from the second coverage area to the first coverage area was or will be taken. The message from the communications network may be an RRC reconfiguration message. Such message may further include that DRBs corresponding to the network slice are now available to use for UL. Receiving an explicit indication from the RAN, i.e., the message as indicated above, whether a slice or service is supported may enhance consistence between RAN and UE. The RAN may know from the cell ID, etc. whether a coverage area provides the network slice.

At block 1120, the network receives from the user device a message indicating the change from the second coverage area to the first coverage area. The message from the UE may indicate that the UE has re-activated data transmission of a data session established in the first coverage area or another coverage area for the network slice.

In some examples, the method 1100 may further comprise, at block 1130, the network re-activates a network slice data session maintained at the communications network, wherein the network slice data session has been previously established for the user device in the first coverage area or another coverage area providing the network slice. As such, at least the context of the data session corresponding to the network slice, such as a PDU session, is or was kept or stored at the network. The maintained session context may include information like a session ID, an IP or protocol configuration for restarting the session, a state of the session and the like. Further, the method may have included storing or buffering data from the data session like e.g., DL data. The maintaining may have included to inform AMF, SMF and/or further network functions. The maintaining may have also included to block DL.

In some examples, the method 1100 may further comprise activating or re-activating a data radio bearer related to the data session. The activating may affect one or more data radio bearers.

In some examples, the method 1100 may further comprise sending buffered downlink data of the network slice, wherein the buffered downlink data is previously buffered downlink data of the network slice for the network slice data session which has been previously established for the user device for the network slice in the first coverage area or another coverage area providing the network slice allowed for the user device

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE and 5G NR, similar principles can be applied in relation to other networks and communication systems where enforcing fast connection re-establishment is required. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes exemplary embodiments, there are several variations and modifications which may be made to the disclosed solution without departing from the scope of the subject disclosure.

In general, the various exemplary embodiments may be implemented in hardware or special purpose circuits, software, logic or any combination thereof. Some aspects of the subject disclosure may be implemented in hardware, while other aspects may be implemented in firmware or software which may be executed by a controller, microprocessor or other computing device, although the subject disclosure is not limited thereto. While various aspects of the subject disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Example embodiments of the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Example embodiments of the subject disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of the subject disclosure. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of the subject disclosure as defined in the appended claims. Indeed, there is a further embodiment comprising a combination of one or more embodiments with any of the other embodiments previously discussed.

1. Method of operating a user device in a communications network; the method comprising
determining a change of the user device from a first coverage area providing a network slice allowed for the user device to a second coverage area not providing the network slice,
suspending data transmission of a data session established in the first coverage area or another coverage area for the network slice, and
maintaining a user device data session context for the data session.

2. Method according to claim 1, wherein
the suspending includes releasing a user device data radio bearer related to the data session or deactivating the user device data radio bearer.

3. Method according to one of the preceding claims, wherein
the determining includes receiving a message from the communications network that the network slice is not provided.

4. Method according to one of the preceding claims, wherein
the determining includes receiving a message from the communications network indicating to the user device to suspend the data session.

5. Method according to one of the preceding claim 3 or 4, wherein the message from the communications network is an RRC reconfiguration message.

6. Method according to one of the preceding claims, wherein
the determining includes detecting, by the user device, that the network slice is not provided.

7. Method according to one of the preceding claims, wherein
the maintaining includes, by the user device, maintaining the data session at a non-access stratum and suspending the data session at an access stratum.

8. Method according to one of the preceding claims, wherein
the first coverage area is a first tracking area, and/or
the second coverage area is a second tracking area.

9. Method according to one of the preceding claims, wherein the data session is a PDU session.

10. Method according to one of the preceding claims, wherein the user device is in a connected mode in at least one of the first coverage area and the second coverage area.

11. Method according to one of the preceding claims, further comprising
sending, to the network, a message indicating the change from the first coverage area to the second coverage area.

12. Method of operating a network device in a communications network comprising a first coverage area providing a network slice allowed for a user device and a second coverage area not providing the network slice; the method comprising
sending a message to the user device indicating a change from a first coverage area providing a network slice allowed for the user device to a second coverage area not providing the network slice, the message including information indicating to the user device to suspend a data session established for the network slice,
receiving, from the user device, a message indicating the change from the first coverage area to the second coverage area.

13. Method according to claim 12, wherein
the first coverage area is a first tracking area, and/or
the second coverage area is a second tracking area.

14. Method according to one of the claim 12 or 13, wherein the data session is a PDU session.

15. Method according to one of the claims 12 to 14, further comprising
maintaining a network device data session context for the data session if the user device is in the second coverage area.

16. Method according to one of the claims 12 to 15, further comprising
deactivating a network data radio bearer related to the network slice data session upon receiving the message indicating the change from the first coverage area to the second coverage area.

17. Method according to claim 16, wherein the deactivating the network data radio bearer comprises deactivating a tunnel related to the data session and/or maintaining data session context for the network slice while the user device is in the second coverage area.

18. Method according to one of the claims 12 to 17, further comprising
buffering and/or discarding downlink data of the network slice after receiving the message indicating the change from the first coverage area to the second coverage area.

19. Method according to claim 18, further comprising indicating the amount of discarded data to the communications network.

20. Method of operating a user device in a communications network; the method comprising:
determining a change of the user device from a second coverage area not providing a network slice allowed for the user device to a first coverage area providing the network slice,
re-activating data transmission of a data session from a user device data session context maintained at the user device, wherein the data session has been previously established for the network slice in the first coverage area or another coverage area providing the network slice allowed for the user device.

21. Method according to claim 20, wherein
the determining includes receiving a message from the communications network that the network slice is provided.

22. Method according to one of claim 20 or 21, wherein
the determining includes receiving a message from the communications network indicating to the user device to re-activate the data session.

23. Method according to one of the claims 20 to 22, wherein the message from the communications network includes information indicating to the user device to set-up a user device data radio bearer for the re-activated data session, wherein the method further comprises establishing a user device data radio bearer for the re-activated data session.

24. Method according to one of claims 21 to 23, wherein the message from the communications network is an RRC reconfiguration message.

25. Method according to one of claims 20 to 24, wherein
the determining includes detecting, by the user device, that the network slice is provided.

26. Method according to the preceding claims 20 to 25, wherein the re-activating includes setting-up or activating a user device data radio bearer for the re-activated data session.

27. Method according to one of the claims 20 to 26, wherein
the first coverage area is a first tracking area, and/or
the second coverage area is a second tracking area.

28. Method according to one of the claims 20 to 27, wherein the data session is a PDU session.

29. Method according to one of the claims 20 to 28, further comprising
sending, to the network, a message indicating the change from the second coverage area to the first coverage area.

30. Method of operating a network device in a communications network comprising a first coverage area providing a network slice allowed for a user device and a second coverage area not providing the network slice; the method comprising
sending a message to the user device indicating a change from a second coverage area not providing a network slice allowed for the user device to a first coverage area providing the network slice, the message including information indicating to the user device to re-activate a data session with the network slice, from a user device data session context maintained at the user device, wherein the data session has been previously established for the network slice in the first coverage area or another coverage area providing the network slice allowed for the user device,
receiving, from the user device, a message indicating the change from the second coverage area to the first coverage area.

31. Method according to claim 30, wherein
the first coverage area is a first tracking area, and/or
the second coverage area is a second tracking area.

32. Method according to one of the claims 30 to 31, wherein the data session is a PDU session.

33. Method according to one of the claims 30 to 32, further comprising
re-activating a network slice data session maintained at the communications network, wherein the network slice data session has been previously established for the user device in the first coverage area or another coverage area providing the network slice.

34. Method according to one of the claims 30 to 33, further comprising
setting-up a network data radio bearer related to the network slice data session.

35. Method according to one of the claims 30 to 34, further comprising
sending buffered downlink data of the network slice, wherein the buffered downlink data is previously buffered downlink data of the network slice for the network slice data session which has been previously established for the user device for the network slice in the first coverage area or another coverage area providing the network slice allowed for the user device.

36. User device, comprising
at least one processor; and
at least one memory including computer program code, wherein the computer program code causes the user device, when executed with the at least one processor, to at least:
determine a change of the user device from a first coverage area providing a network slice allowed for the user device to a second coverage area not providing the network slice,
suspend data transmission of a data session established in the first coverage area or another coverage area for the network slice, and
maintain, at the user device, a user device data session context for the data session.

37. User device according to claim 36, wherein
the computer program code further causes the user device, when executed with the at least one processor, to perform a method according to any one of claims 2 to 11.

38. User device, comprising
at least one processor; and
at least one memory including computer program code, wherein the computer program code causes the user device, when executed with the at least one processor, to at least:
determine a change of the user device from a second coverage area not providing a network slice allowed for the user device to a first coverage area providing the network slice,
re-activate data transmission of a data session from a user device data session context maintained at the user device, wherein the data session has been previously established for the network slice in the first coverage area or another coverage area providing the network slice allowed for the user device.

39. User device according to claim 38, wherein
the computer program code further causes the user device, when executed with the at least one processor, to perform a method according to any one of claims 21 to 29.

40. Network device, comprising
at least one processor; and
at least one memory including computer program code, wherein the computer program code causes the network device, when executed with the at least one processor, to at least:
send a message to the user device indicating a change from a first coverage area providing a network slice allowed for the user device to a second coverage area not providing the network slice, the message including information indicating to the user device to suspend a data session established for the network slice,
receive, from the user device, a message indicating the change from the first coverage area to the second coverage area.

41. Network device according to claim 40, wherein
the computer program code further causes the user device, when executed with the at least one processor, to perform a method according to any one of claims 13 to 19.

42. Network device, comprising
at least one processor; and
at least one memory including computer program code, wherein the computer program code causes the network device, when executed with the at least one processor, to at least:
send a message to the user device indicating a change from a second coverage area not providing a network slice allowed for the user device to a first coverage area providing the network slice, the message including information indicating to the user device to re-activate a data session with the network slice, from a user device data session context maintained at the user device, wherein the data session has been previously established for the network slice in the first coverage area or another coverage area providing the network slice allowed for the user device,
receive, from the user device, a message indicating the change from the second coverage area to the first coverage area.

43. Network device according to claim 42, wherein
the computer program code further causes the user device, when executed with the at least one processor, to perform a method according to any one of claims 31 to 35.

44. User device, comprising
means of determining a change of the user device from a first coverage area providing a network slice allowed for the user device to a second coverage area not providing the network slice,
means of suspending data transmission of a data session established in the first coverage area or another coverage area for the network slice, and
means of maintaining a user device data session context for the data session.

45. User device according to claim 44, wherein
the computer program code further causes the user device, when executed with the at least one processor, to perform a method according to any one of claims 2 to 11.

46. User device, comprising
means of determining a change of the user device from a second coverage area not providing a network slice allowed for the user device to a first coverage area providing the network slice,
means of re-activating data transmission of a data session from a user device data session context maintained at the user device, wherein the data session has been previously established for the network slice in the first coverage area or another coverage area providing the network slice allowed for the user device.

47. User device according to claim 46, wherein
the computer program code further causes the user device, when executed with the at least one processor, to perform a method according to any one of claims 21 to 29.

48. Network device, comprising
means of sending a message to the user device indicating a change from a first coverage area providing a network slice allowed for the user device to a second coverage area not providing the network slice, the message including information indicating to the user device to suspend a data session established for the network slice,
means of receiving, from the user device, a message indicating the change from the first coverage area to the second coverage area.

49. Network device according to claim 48, wherein
the computer program code further causes the network device, when executed with the at least one processor, to perform a method according to any one of claims 13 to 19.

50. Network device, comprising
means of sending a message to the user device indicating a change from a second coverage area not providing a network slice allowed for the user device to a first coverage area providing the network slice, the message including information indicating to the user device to re-activate a data session with the network slice, from a user device data session context maintained at the user device, wherein the data session has been previously established for the network slice in the first coverage area or another coverage area providing the network slice allowed for the user device,
means of receiving, from the user device, a message indicating the change from the second coverage area to the first coverage area.

51. Network device according to claim 50, wherein
the computer program code further causes the network device, when executed with the at least one processor, to perform a method according to any one of claims 31 to 35.

52. Non-transitory computer-readable media containing computer-executable instructions which when run on one or more processors perform the steps of the method according to any one of claims 1 to 11 or 20 to 29.

53. Non-transitory computer-readable media containing computer-executable instructions which when run on one or more processors perform the steps of the method according to any one of claims 12 to 19 or 31 to 35.
